(19) United States
(12) Patent Application Publication
(10) Pub. No.: US 2015/0067590 A1
(43) Pub. Date: Mar. 5, 2015

(54) METHOD AND APPARATUS FOR SHARING OBJECTS IN ELECTRONIC DEVICE

(71) Applicant: Samsung Electronics Co., Ltd., Suwon-si (KR)

(72) Inventors: Dongjun LEE, Gumi-si (KR); Hyunwoong KWON, Daegu (KR); Dongjeon KIM, Anyang-si (KR); Hyesoon JEONG, Chilgok-gun (KR)

(21) Appl. No.: 14/469,971

(22) Filed: Aug. 27, 2014

(30) Foreign Application Priority Data
Aug. 30, 2013 (KR) 10-2013-0104528

(51) Int. Cl. G06F 3/0484

(52) U.S. Cl. CPC G06F 3/04842
USPC 715/803

(57) ABSTRACT

A method and apparatus for sharing objects between windows in an electronic device supporting multiple windows are provided. The method for sharing objects in an electronic device includes displaying multiple windows including a first window and a second window on a display unit functionally linked with the electronic device, selecting the first window, activating objects associated with the first window, receiving an input signal for selecting at least one of the objects associated with the first window, and presenting the selected at least one of the objects in a region associated with the second window according to an attribute of the input signal.

### CROSS-REFERENCE TO RELATED APPLICATION(S)

This application claims the benefit under 35 U.S.C. §119(a) of a Korean patent application filed on Aug. 30, 2013 in the Korean Intellectual Property Office and assigned Serial number 10-2013-0104528, the entire disclosure of which is hereby incorporated by reference.

### TECHNICAL FIELD

The present disclosure relates to a method and apparatus for sharing objects between windows in an electronic device supporting multiple windows.

### BACKGROUND

Recent advances in digital technologies have enabled development of various types of electronic devices supporting communication and personal information processing, such as mobile communication terminals, Personal Digital Assistants (PDA), electronic notes, smartphones, tablet computers, and the like. High-end electronic devices have evolved into mobile convergence devices supporting heterogeneous functions having originated from distinct fields. For example, such an electronic device may support various functions related to calls (voice call and video call), messages (Short Message Service (SMS), Multimedia Message Service (MMS) and electronic mail), navigation, image capture, broadcast reception and display, media playback (video and music), Internet, instant messengers, Social Networking Services (SNS), and the like.

Latest electronic devices are increasingly equipped with large screens. That is, large screens combined with touch capabilities have largely eliminated size and input limitations of existing electronic devices having small screens. A portable electronic device such as a tablet computer may provide a multi-screen feature enabling simultaneous use of two or more applications. By use of such a multi-screen feature, a user can process two independent tasks at the same time on a single electronic device, and can increase processing efficiency even when only one task is processed.

To share objects in an electronic device supporting a multi-screen feature, the copy and paste function or the drag and drop function may be used. However, use of the copy and paste function may require repeated user input, and the drag and drop function may cause a potential conflict between uses as it may also be used for different purposes other than object sharing.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device supporting multiple windows and a method for efficiently sharing objects between windows in the electronic device.

In various embodiments of the present disclosure, the electronic device may be any electronic appliance having at least one of an Application Processor (AP), Graphics Processing Unit (GPU) and Central Processing Unit (CPU), such as an information and communication device, multimedia device, wearable device or applied device, but is not limited thereto.

Another aspect of the present disclosure is to provide an electronic device and operation method therefor that realize an optimum environment for object sharing in such a manner as to increase user convenience and device usability.

In accordance with an aspect of the present disclosure, a method for sharing objects in an electronic device is provided. The method may include displaying multiple windows including a first window and a second window on a display unit functionally linked with the electronic device, selecting the first window, activating objects associated with the first window, receiving an input signal for selecting at least one of the objects associated with the first window, and presenting the selected at least one of the objects in a region associated with the second window according to an attribute of the input signal.

In accordance with another aspect of the present disclosure, a computer readable storage medium is provided. The computer readable storage medium may store a program that enables the above method to be executed on a processor.

In accordance with another aspect of the present disclosure, an electronic device is provided. The electronic device may include a display unit functionally linked with the electronic device to display multiple windows including a first window and a second window and to display objects on the first and second windows, a touch sensor configured to detect input signals for, selecting at least one of the multiple windows, selecting at least one object on the selected at least one of the multiple windows, and sharing the selected at least one object, and a control unit configured to control a process of activating objects associated with the first window according to selection of the first window, and to present, according to an attribute of the input signals for selecting the at least one object, the selected at least one object in a region associated with the second window.

More specifically, the computer readable storage medium may store a program implementing a method for sharing objects in an electronic device, the method comprising displaying multiple windows including a first window and a second window on a display unit functionally linked with the electronic device, selecting the first window, activating objects associated with the first window, receiving an input signal for selecting at least one of the objects associated with the first window, and presenting the selected at least one of the objects in a region associated with the second window according to the attribute of the input signal.

Hereinabove, the features and advantages of the present disclosure are described in a relatively broad perspective to help those skilled in the art understand the present disclosure. Other features and advantages constituting the subject matter of the present disclosure will be more apparent from the following detailed description.

In a feature of the present disclosure, the electronic device and object sharing method therefor enable object sharing between multiple windows through the drag and drop function. Hence, it is possible to avoid inconvenience caused by the copy and paste function requiring repeated user input.

In various embodiments of the present disclosure, an object contained in multiple windows may become a target for sharing. Hence, the user may share objects between multiple windows in an intuitive manner. Consequently, it is possible to realize an optimum environment for object sharing in an electronic device so as to enhance user convenience and increase usability and competitiveness of the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIGS. 2, 3, 4, 5, and 6 are screen representations illustrating object sharing between windows in an electronic device according to an embodiment of the present disclosure;

FIG. 7 is a flowchart illustrating a method for object sharing in an electronic device according to an embodiment of the present disclosure;

FIG. 8 is a flowchart illustrating another method for object sharing in an electronic device according to an embodiment of the present disclosure; and

FIG. 9 is a flowchart illustrating another method for object sharing in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the present disclosure relate to a method and apparatus that enable easy and efficient sharing of objects between multiple windows in an electronic device supporting multiple windows. A plurality of windows may be provided through a multi-screen feature of the electronic device. In the electronic device, the display unit such as a touchscreen may be divided into multiple regions and the multi-screen feature enables execution of one or more applications in each screen region.

In one embodiment, among multiple windows (e.g. first and second windows) provided by the electronic device, one window (e.g. the first window) may be selected (or focused) in response to a user action. Then, the electronic device may determine whether a sharable object is present among objects on the selected window. Here, a sharable object is an object that may be selected and dragged to the other window (for movement or copy) by the user.

When at least one of the multiple windows is selected, the electronic device may determine whether to activate object sharing mode. For example, when the first window is selected, the electronic device may determine whether an object on the first window is to be shared with another window (e.g. the second window). In one embodiment, the electronic device may provide a sharing mode switching button for activating object sharing mode as part of the User Interface (UI). The sharing mode switching button may be displayed in a region such as a region of the first window with focus, a region of the second window without focus, a soft key region, or a menu region, but is not limited thereto.

When the sharing mode switching button is selected by the user, the electronic device may activate object sharing mode. Upon activation of object sharing mode, the electronic device may place a highlight on one or more sharable objects. During object sharing mode, when one of the sharable objects is selected, the electronic device may move or copy the selected object (object to be shared) from the first window to the second window and display the object on the second window. During object sharing mode, when a portion other than the object to be shared in the first window or the second window is selected, the electronic device may automatically deactivate object sharing mode.

In the following description, a touch-based event or gesture is used as user input for object sharing. However, the present disclosure is not limited thereto. That is, in addition to a touch-based event or gesture, a hovering event without direct contact with the touchscreen or a hand gesture recognizable through a sensor of any type may be used as user input for object sharing.

In various embodiments, touch-based input may include touch, tap, double tap, drag, sweep, flick, drag and drop, or the like. Various sensors such as a speech recognition sensor, gyro sensor, geomagnetic sensor, acceleration sensor, image sensor, motion sensor, infrared sensor, illumination sensor and the like may be used for detecting user input. User input based on a hand gesture may correspond to an action caused by a finger or specific object and detected by a sensor or to a change in the attitude of the electronic device detected by a sensor, during display of multiple windows. That is, user input for object sharing may be any interaction generated by the user for sharing an object between multiple windows.

Next, a description is given of the configuration and operation of an electronic device with reference to the drawings. However, the configuration and operation thereof are not limited to by the following description, and various changes and modifications are possible based on the following description.

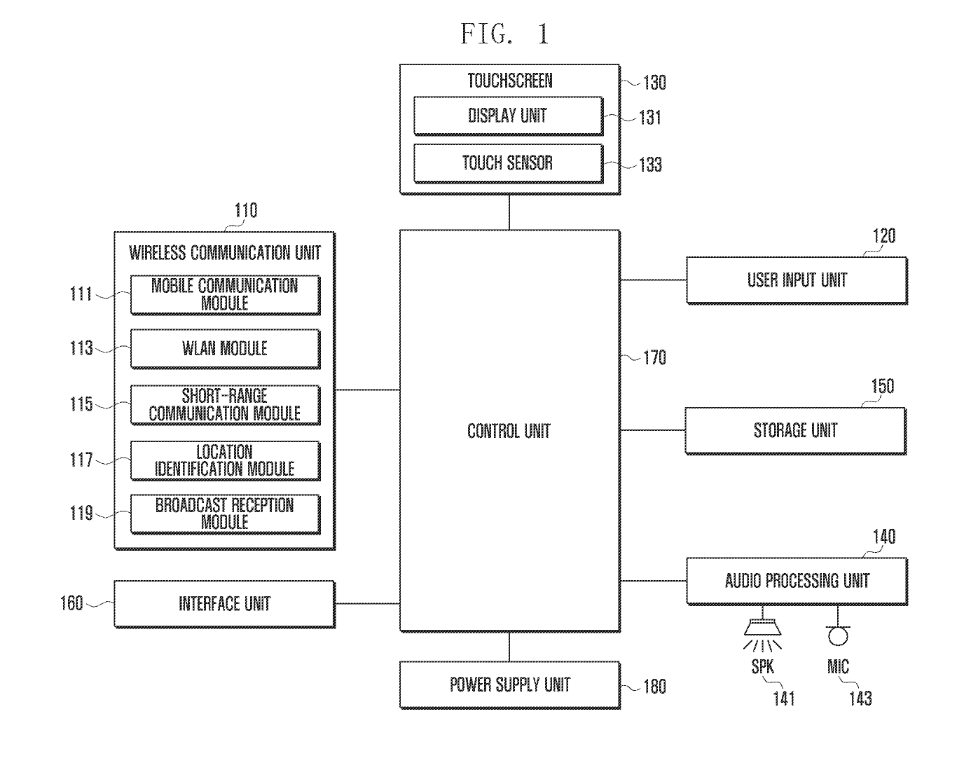

FIG. 1 is a block diagram of an electronic device according to an embodiment of the present disclosure.

Referring to FIG. 1, the electronic device of the present disclosure may include a wireless communication unit 110, a user input unit 120, a touchscreen 130, an audio processing unit 140, a storage unit 150, an interface unit 160, a control unit 170, and a power supply unit 180. As the components shown in FIG. 1 are not indispensable in various embodiments, the electronic device may further include one or more units not shown in FIG. 1, and one or more units of the electronic device shown in FIG. 1 may be removed or replaced. For example, when the electronic device is configured to support an image capture function, a camera module (not shown) may be further included. When the electronic device does not support a broadcast reception and playback function, the broadcast reception module 119 of the wireless communication unit 110 may be omitted.

The wireless communication unit 110 may include one or more modules that support wireless communication between the electronic device and a wireless communication system or between the electronic device and another electronic device. For example, the wireless communication unit 110 may include a mobile communication module 111, a Wireless Local Area Network (WLAN) module 113, a short-range communication module 115, a location identification module 117, and a broadcast reception module 119, but is not limited thereto.

The mobile communication module 111 may send and receive radio signals to and from at least one of a base station, an external terminal, and a server (such as an integration server, provider server, content server, Internet server, cloud server, and the like) on a mobile communication network. The radio signals may carry various types of data in relation to voice calls, video calls, and text or multimedia messages. In particular, the mobile communication module 111 may send an object to be shared selected from one of the multiple windows to an external entity such as a server or another electronic device according to a user request, or receive an object to be shared from an external entity, such as a server or another electronic device, but is not limited thereto.

The WLAN module 113 may be used to wirelessly access the Internet and to establish a WLAN link to another electronic device. The WLAN module 113 may be a built-in module or a removable module. Wireless Internet access may be achieved through Wi-Fi, Wireless Broadband (WiBro), Worldwide Interoperability for Microwave Access (WiMAX), and High Speed Downlink Packet Access (HSDPA). The WLAN module 113 may send data input by the user through a messenger application to the outside or receive data from an external entity. The WLAN module 113 may send an object to be shared selected from one of the multiple windows to an external entity such as a server according to a user request, or receive an object to be shared from an external entity. When a WLAN link to a different electronic device is established, the WLAN module 113 may send and receive various data (e.g. an image, moving image, song and object to be shared) to and from the different electronic device according to user selection. The WLAN module 113 may be always on or may be turned on according to user settings or user input.

The short-range communication module 115 is used to support short-range communication. Short-range communication may be provided through Bluetooth, Bluetooth Low Energy (BLE), Radio Frequency Identification (RFID), Infrared Data Association (IrDA), Ultra Wideband (UWB), ZigBee, and Near Field Communication (NFC), but is not limited thereto. When a short-range communication link to a different electronic device is established, the short-range communication module 115 may send and receive various data (e.g. an image, moving image, song and object to be shared) to and from the different electronic device according to user selection. The short-range communication module 115 may be always on or may be turned on according to user settings or user input.

The location identification module 117 is used to identify the location of the electronic device. A representative example of the location identification module 117 is a Global Positioning System (GPS) module. The location identification module 117 may compute the latitude, longitude and altitude of the current location by applying triangulation to distance and time information received from three or more base stations. The location identification module 117 may also identify the current location by use of signals received in real time from three or more satellites, but is not limited thereto. Location information may be obtained in various ways.

The broadcast reception module 119 may receive a broadcast signal (e.g. a TV broadcast signal, radio broadcast signal or data broadcast signal) and associated information (e.g. information regarding broadcast channels, broadcast programs and broadcast service providers) from an external broadcasting server through a broadcast channel (e.g. satellite channel or terrestrial channel).

The user input unit 120 may generate an input signal for controlling the electronic device corresponding to user manipulation. The user input unit 120 may include a keypad, dome switch, touchpad (resistive or capacitive), jog wheel, jog switch, sensor (such as a voice sensor, proximity sensor, illumination sensor, acceleration sensor, or gyro sensor), and the like. The user input unit 120 may include buttons formed on the exterior of the electronic device and/or virtual buttons on a touch panel. The user input unit 120 may receive user input for initiating the object sharing function of an embodiment and generate an input signal corresponding to the user input.

The touchscreen 130 is an input/output device supporting both an input function and a display function, and may include a display unit 131 and a touch sensor 133. In the touchscreen 130, various screens for operation of the electronic device, such as a messenger screen, call handling screen, gaming screen and gallery screen, are displayed on the display unit 131. The touchscreen 130 may display a screen of an application currently being executed on a single window in a full-screen format or may display screens of applications currently being executed on multiple windows in a multi-screen format. When a user event (such as a touch event or hovering event) is detected by the touch sensor 133 in a state wherein multiple screens are displayed as windows on the display unit 131, the touchscreen 130 may send an input signal corresponding to the user event to the control unit 170, which may then identify the user event and control an operation according to the user event.

The display unit 131 may display or output information processed by the electronic device. For example, when the electronic device is in call handling mode, the display unit 131 may display a User Interface (UI) or Graphical User Interface (GUI) for call handling. When the electronic device is in video call mode or capture mode, the display unit 131 may output a UI or GUI for displaying received or captured images. The display unit 131 may display multiple application screens on multiple windows. The display unit 131 may set focus on a window selected from among the multiple windows according to user selection and place a highlight on an object to be shared on the focused window. In response to user input, the display unit 131 may move or copy the object to be shared on the focused window to a different window and display the moved or copied object on the different window. In addition, the display unit 131 may display the screen in a landscape format or portrait format and may switch between landscape and portrait formats according to rotation or placement of the electronic device, but is not limited thereto. Examples of screens on the display unit 131 are described later with reference to the drawings.

The display unit 131 may be realized using one or more display techniques based on Liquid Crystal Display (LCD), Thin Film Transistor Liquid Crystal Display (TFT-LCD), Light Emitting Diodes (LED), Organic Light Emitting Diodes (OLED), Active Matrix OLEDs (AMOLED), flexible display, bendable display, and 3D display. The display unit 131 may also use a transparent display technology so as to be seen from the outside.

The touch sensor 133 may be placed on the display unit 131 and may detect user input of touching the surface of the touchscreen 130, such as tap, drag, sweep, flick, drag and drop, drawing, long press, single-point touch, multipoint touch, handwriting, and the like. When a touch event is detected on the surface of the touchscreen 130, the touch sensor 133 may identify the coordinates of the portion wherein the touch event is detected and send the coordinate information to the control unit 170. Upon detection of user input, the touch sensor 133 may generate an input signal corresponding to the user input and send the input signal to the control unit 170, which then may perform a function according to the area in which the user input is generated.

The touch sensor 133 may detect a hovering event caused by an input instrument (e.g. a finger or electronic pen) hovering over the surface of the touchscreen 130 and send an input signal corresponding to the hovering event to the control unit 170. The touch sensor 133 may detect presence, absence or movement of the input instrument, which hovers over the surface of the touchscreen 130 at a given distance without direct contact, by measuring the amount of current. Upon reception of an input signal from the touch sensor 133, the control unit 170 may identify a hovering event indicated by the input signal and perform a control function corresponding to the identified hovering event.

The touch sensor 133 may detect user input for setting focus on one of the multiple windows and generate an input signal corresponding to the user input. The touch sensor 133 may detect user input on the sharing mode switching button provided by the window with focus and generate an input signal corresponding to the user input. The touch sensor 133 may detect user input for selecting an object to be shared on the focused window and generate an input signal corresponding to the user input.

The touch sensor 133 may convert a pressure change or capacitance change detected at a site of the display unit 131 into an electrical signal. The touch sensor 133 may detect the position and area of user touch input and may also detect pressure caused by touch input according to a touch technique employed. Upon detection of touch input, the touch sensor 133 may send a corresponding electrical signal to a touch controller (not shown). The touch controller may process the received electrical signal and send data corresponding to the processed result to the control unit 170. Thereby, the control unit 170 may identify the touch point on the touchscreen 130 and the like.

The audio processing unit 140 may send an audio signal from the control unit 170 to a speaker 141, and may send an audio signal such as a voice signal from a microphone 143 to the control unit 170. Under control of the control unit 170, the audio processing unit 140 may convert voice or audio data into an audio signal and output the audio signal through the speaker 141, and may convert an audio signal such as a voice signal from the microphone 143 into a digital signal and send the digital signal to the control unit 170.

The speaker 141 may be used to output audio data received through the wireless communication unit 110 or stored in the storage unit 150 during instant messaging, call handling, message transmission, sound or video recording, speech recognition, broadcast reception, media playback (music or video), or object sharing mode (or drag mode). The speaker 141 may also be used to output sound effects related to functions being executed by the electronic device (e.g. activation of multiple windows, messenger execution, message reception, message transmission, content image display, content-related function execution, call reception, call placement, image capture and content playback).

The microphone 143 may be used to receive an audio signal from the outside and convert the audio signal to electrical audio data during instant messaging, call handling, message transmission, sound or video recording, speech recognition, or object sharing mode. During a call, the processed audio data may be converted into a format transmittable to a base station through the mobile communication module 111. The microphone 143 may implement a variety of noise removal algorithms to remove noise occurring while receiving an audio signal from the outside.

The storage unit 150 may store programs for processing and control operations of the control unit 170, and may temporarily store input/output data, such as objects to be shared, messenger or conversation data, content images, contacts information, messages, media content (audio, video and images), and the like. The storage unit 150 may store information regarding usage frequencies, importance or priorities of applications, shared objects and content. The storage unit 150 may store information regarding a variety of vibrations and sound effects output in response to touch input on the touchscreen 130. The storage unit 150 may store information regarding objects to be shared according to user input during object sharing mode, schemes to share objects (e.g. move, copy and transfer), and agents sharing objects (e.g. application on a different window, external electronic device, and external server).

The storage unit 150 may temporarily or semi-permanently store an Operating System (OS) of the electronic device, programs supporting input and display operations of the touchscreen 130, programs for controlling object sharing between windows, and data generated during program execution, but is not limited thereto.

The storage unit 150 may include one or more of various types of storage media, such as flash memory, hard disk, multimedia or other memory card (micro, SD or XD), Dynamic Random Access Memory (DRAM), Static Random Access Memory (SRAM), Read Only Memory (ROM), programmable read-only memory (PROM), Electrically Erasable Programmable Read-Only Memory (EEPROM), Magnetic Read Only Memory (MRAM), magnetic disk, and optical disc. In the electronic device, the storage unit 150 may function in cooperation with a Web storage over the Internet.

The interface unit 160 acts as a channel enabling an external device to connect to the electronic device. The interface unit 160 may be used to receive data or power from an external device and to send internal data of the electronic device to the external device, but is not limited thereto. For example, the interface unit 160 may include a wired/wireless headset port, charger port, wired/wireless data port, memory card port, port for an appliance with an identification module, audio input/output port, video input/output port, and earphone port.

The control unit 170 may control the overall operation of the electronic device. For example, the control unit 170 may control operations related to voice communication, data communication, and video communication. In particular, the control unit 170 may include a processing module (not shown) to display multiple windows and handle operations for object sharing between the multiple windows.

The control unit 170 may implement a multi-screen feature using multiple windows, and select one or more of the multiple windows.

In one embodiment, when at least one of the multiple windows is selected (e.g. a first window receives focus), the control unit 170 may activate (or transition to) object sharing mode.

In another embodiment, when at least one window is selected, the control unit 170 may display, for example, a sharing mode switching button for transitioning to object sharing mode. Upon detection of user input on the sharing mode switching button, the control unit 170 may activate (or transition to) object sharing mode.

In another embodiment, when at least one window is selected, the control unit 170 may determine whether objects on the selected window (e.g. first window) are sharable with another window (e.g. second window not selected). Upon determining that objects are sharable with another window, the control unit 170 may activate (or transition to) object sharing mode.

In another embodiment, when at least one window is selected, the control unit 170 may determine whether objects on the selected window are sharable with another window. Upon determining that objects are sharable with another window, the control unit 170 may display a sharing mode switching button for transitioning to object sharing mode, but is not limited thereto. Upon detection of user input on the sharing mode switching button, the control unit 170 may activate (or transition to) object sharing mode.

In the present disclosure, object sharing mode may be activated in one of the above schemes and may be configured differently according to user settings.

In one embodiment, upon activation of object sharing mode, the control unit 170 may place a highlight on sharable objects on the selected or focused window so that the user may be clearly aware of the presence of sharable objects. Here, placement of a highlight on a sharable object may be selectively performed according to user settings. When one of the sharable objects is selected as an object to be shared from the selected window, the control unit 170 may move or copy the object to be shared to another window (or a window of a different electronic device) and display the same. The control unit 170 may also move or copy the object to be shared within the selected window.

Control operations of the control unit 170 will be described in more detail later with reference to the drawings.

In addition to the above operations, the control unit 170 may control regular operations of the electronic device. For example, when an application is executed, the control unit 170 may control application execution and screen display for the application. The control unit 170 may receive an input signal corresponding to a touch event (or hovering event) generated on the input interface (such as the touchscreen 130) and control function execution according to the input signal. The control unit 170 may also control transmission and reception of various types of data through wired or wireless communication.

The power supply unit 180 may supply power from an external or internal power source to the individual components of the electronic device under control of the control unit 170.

According to various embodiments of the present disclosure, the electronic device may be any electronic appliance having an Application Processor (AP), Graphics Processing Unit (GPU) and Central Processing Unit (CPU), such as an information and communication device, multimedia device or applied device. For example, the electronic device may be a mobile communication terminal based on communication protocols supporting various communication systems, a tablet computer, a smartphone, a wearable device (i.e. a smart device that may be worn or put on by a user, such as a wearable phone, wearable watch, wearable computer, wearable camera, wearable shoes, wearable pendant, wearable ring, wearable bracelet, or wearable glasses or goggles), a Portable Multimedia Player (PMP), a media player such as an MP3 player, a portable game console, and a Personal Digital Assistant (PDA), but is not limited thereto. In addition, the function control scheme of the present disclosure may be applied to various display devices such as a laptop computer, Personal Computer (PC), digital television, Digital Signage (DS), and Large Format Display (LFD).

Various embodiments of the present disclosure can be implemented using hardware, software or a combination thereof. Software implementation can be stored in a storage medium readable by a computer or a similar device. Hardware implementation may be achieved using at least one of an Application Specific Integrated Circuit (ASIC), Digital Signal Processor (DSP), Digital Signal Processing Device (DSPD), Programmable Logic Device (PLD), Field Programmable Gate Array (FPGA), processor, controller, micro-controller, microprocessor, and electric unit realizing a specific function.

Here, the storage medium may be a computer readable storage medium storing a program that is configured to display multiple windows including a first window and a second window on a display unit functionally linked with an electronic device, select the first window, activate an object associated with the first window according to the selection result, receive user input for selecting the object, and provide the object in a region of the second window according to the attribute of the user input.

In one embodiment, the storage medium may store a program that is configured to examine whether a sharable object is present among objects on the first window, and activate object sharing mode if a sharable object is present.

In another embodiment, the storage medium may store a program that is configured to display supplementary information emphasizing the first window (e.g. focus) in a region related to the first window, and display supplementary information emphasizing the sharable object (e.g. highlight).

In another embodiment, the storage medium may store a program that is configured to provide a sharing mode switching button for transitioning to object sharing mode in a region of the multiple windows, and activate object sharing mode in response to user input on the sharing mode switching button.

In another embodiment, the storage medium may store a program that is configured to examine whether an object sharable with the second window is present among objects on the first window, and display the sharing mode switching button if an object sharable with the second window is present on the first window.

In another embodiment, the storage medium may store a program that is configured to examine the attribute of user input, and provide, if the user input involves dragging an object on the first window to the second window and dropping the object on the second window, the object to the second window.

Some embodiments of the present disclosure may be directly implemented by the control unit 170. Procedures and functions described as embodiments in the present specification may be implemented by software modules. Each software module may perform one or more functions or operations described in the present specification.

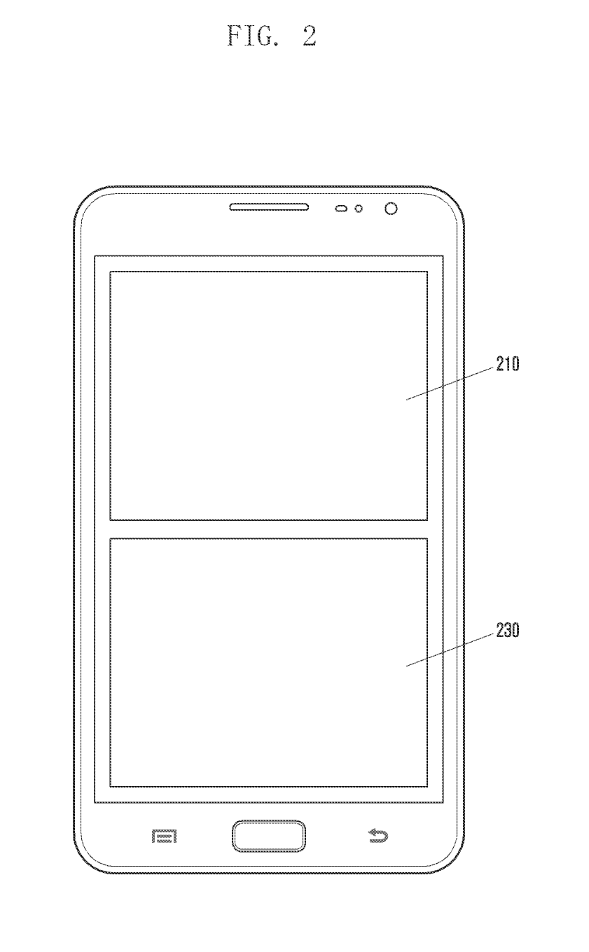

FIGS. 2, 3, 4, 5, and 6 are screen representations illustrating object sharing between windows in an electronic device according to an embodiment of the present disclosure.

FIGS. 2 to 6 depict a case wherein at least two windows (e.g. a first window 210 and second window 230) are presented, and at least one object (object to be shared) among sharable objects on the first window 210 is shared with the second window 230. However, the present disclosure is not limited thereto. For example, according to the screen size of the display unit 131, it is possible to provide three or more windows and the three or more windows may share an object. In addition to object sharing between windows, in a state wherein one or more windows are presented, an object may be shared between different regions of a single window (move or copy) or may be shared with an external electronic device or an external server (transmission).

FIG. 2 may depict a situation wherein the user of the electronic device executes two applications (first and second applications) so that the execution screen of the first application (e.g. webpage or message application) is displayed on the first window 210 and the execution screen of the second application (e.g. messenger or gallery application) is displayed on the second window 230.

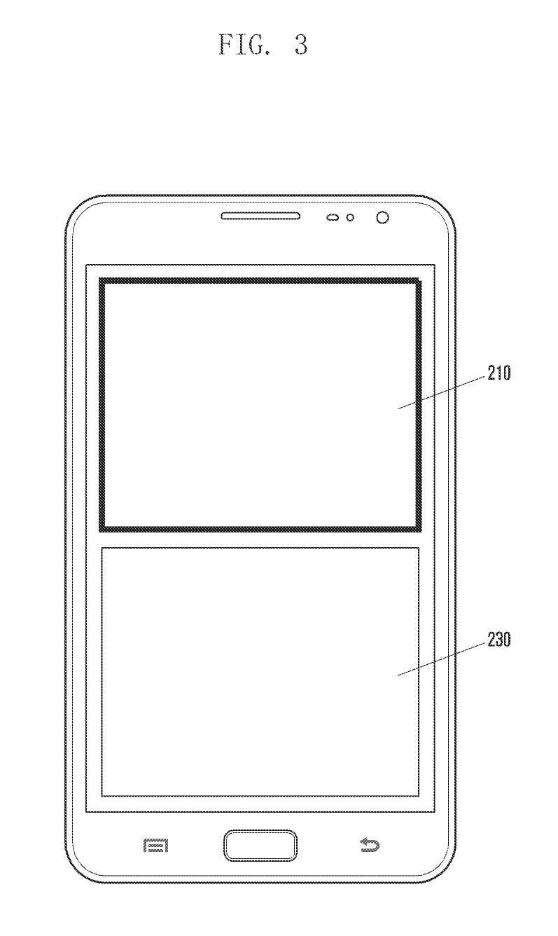

In a state described in FIG. 2, one of the windows may be selected (touched). In a state wherein the multiple windows 210 and 230 are displayed, when one window (for example, the first window 210) is selected, the electronic device may set focus on the first window 210 as shown in FIG. 3. In the present disclosure, focus may be set on a selected window so that the selected window is readily noticeable to the user. Focus may be represented in various ways such as a change in the window border thickness or a change in the window color or shape, but is not limited thereto.

When the first window 210 is focused in response to user input as shown in FIG. 3, the electronic device may analyze objects on the first window 210. In various embodiments of the present disclosure, an object may be a text segment (character string), image, emoticon, Uniform Resource Locator (URL), tag, or banner within an application screen displayed on the corresponding window.

The electronic device may determine whether a sharable object is present on the first window 210 through object analysis. In various embodiments of the present disclosure, a sharable object may be an object displayed on the corresponding window (e.g. the first window 210). For example, among objects, an object that may be moved or copied according to user selection may become a sharable object.

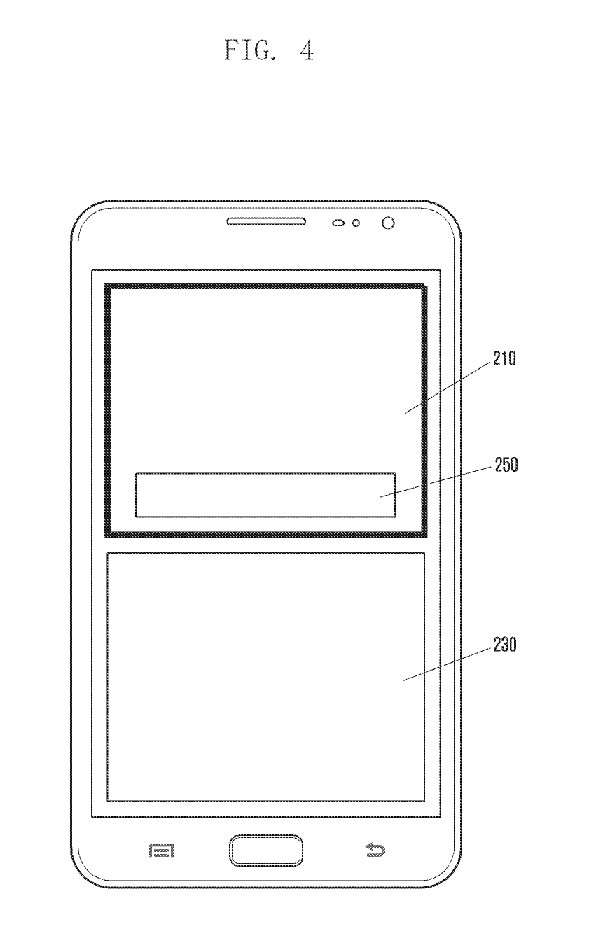

The electronic device may display a sharing mode switching button 250 for activating object sharing mode in response to user input on the first window 210 as shown in FIG. 4, but is not limited thereto. The electronic device may determine whether a sharable object is present on the first window 210 and display the sharing mode switching button 250 if a sharable object is present. Alternatively, the electronic device may display the sharing mode switching button 250 when the first window 210 is selected. If a sharable object is not present when user input for object sharing is detected on the sharing mode switching button 250, the electronic device may notify the user of absence of a sharable object. For example, the electronic device may issue a notification indicating absence of a sharable object through a message, sound effect, LED radiation, and the like.

Referring to FIG. 4, the sharing mode switching button 250 is provided in a region of the first window 210 with focus. However, the present disclosure is not limited thereto and the sharing mode switching button 250 can be provided in other areas or regions. That is, the user may designate a region in which the sharing mode switching button 250 is to be displayed. Hence, the sharing mode switching button 250 may be displayed in various areas or regions according to user settings.

For example, when the user configures settings so that the sharing mode switching button 250 is displayed in a window having focus, the sharing mode switching button 250 may be provided in a region (e.g. lower, upper, right or left end region) of the first window 210. When the user configures settings so that the sharing mode switching button 250 is displayed in a window without focus, the sharing mode switching button 250 may be provided in a region (e.g. lower, upper, right or left end region) of the second window 230 not having focus.

When the user configures settings so that the sharing mode switching button 250 is displayed in a fixed region regardless of a window with focus, the sharing mode switching button 250 may be provided in a region (e.g. lower end region, upper end region, or corner region (upper left, lower left, upper right or lower right) of the full screen). The sharing mode switching button 250 may also be provided in a randomly selected region according to user settings.

The sharing mode switching button 250 shown in FIG. 4 has a rectangular shape in a horizontal direction. However, in various embodiments of the present disclosure, the sharing mode switching button 250 may have one of various shapes including a rectangular shape in a vertical direction, square shape, semicircular shape, circular shape, triangular shape, and the like. The sharing mode switching button 250 may be represented in various forms including a button, an icon, and an entity with a three-dimensional effect.

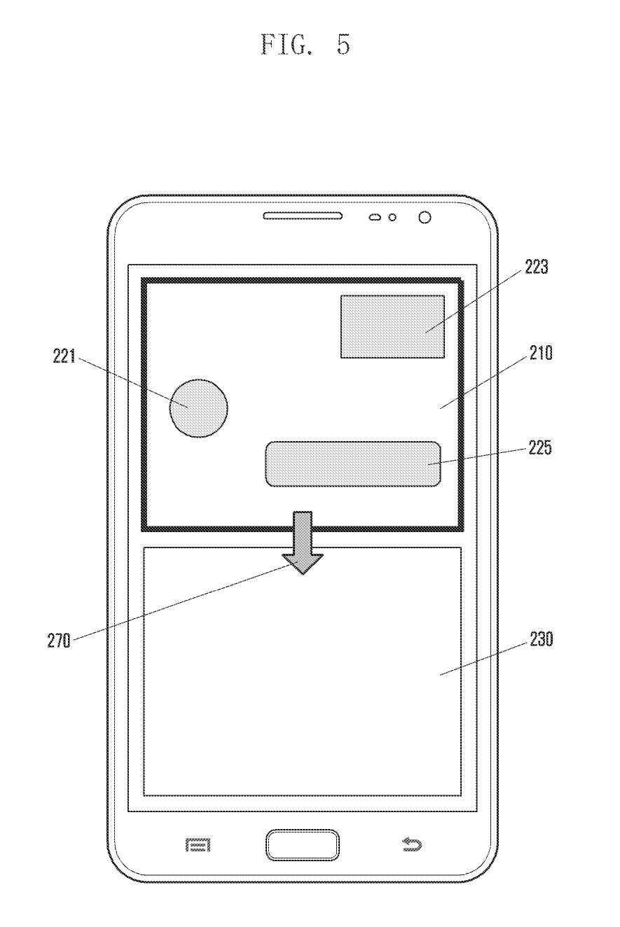

When the sharing mode switching button 250 is provided as shown in FIG. 4, the user may select the sharing mode switching button 250 (by touch or hovering input) for object sharing. Upon reception of user input on the sharing mode switching button 250, the electronic device may activate object sharing mode. Upon activation of object sharing mode, the electronic device may place a highlight on sharable objects 221, 223 and 225 of the first window 210 as shown in FIG. 5. Here, the sharable objects 221, 223 and 225 may have been identified when the first window 210 received focus.

Placement of a highlight on a sharable object may be performed selectively according to user settings. When the user configures settings so that a highlight is placed on a sharable object, a highlight may be placed on sharable objects as shown in FIG. 5. When the user configures settings so that a highlight is not placed on a sharable object, placement of a highlight on a sharable object may be omitted.

When transitioning to object sharing mode, the sharing mode switching button 250 may be hidden as shown in FIG. 5.

A highlight placed on a sharable object may be presented in various ways including drawing of borders, a change of color of the border, addition of a mask layer and a change of color of the object. A highlight placed on a sharable object may clearly distinguish the sharable object from non-sharable objects, so that the user may readily recognize the sharable object. Presentation of a highlight may be determined according to user settings.

In one embodiment, the electronic device may display a direction indicator 270 (similar to an arrow) indicating the movement direction of an object to be shared as shown in FIG. 5. Here, the object to be shared is one of the sharable objects 221, 223 and 225 selected by the user for sharing. One or more sharable objects may be selected for sharing.

The direction indicator 270 may be provided in the boundary between the selected and focused window (e.g. first window 210) and the unfocused window (e.g. second window 230). Multiple direction indicators may be provided. For example, when multiple unfocused windows are present, one direction indicator may be provided in the boundary between the focused window and each unfocused window.

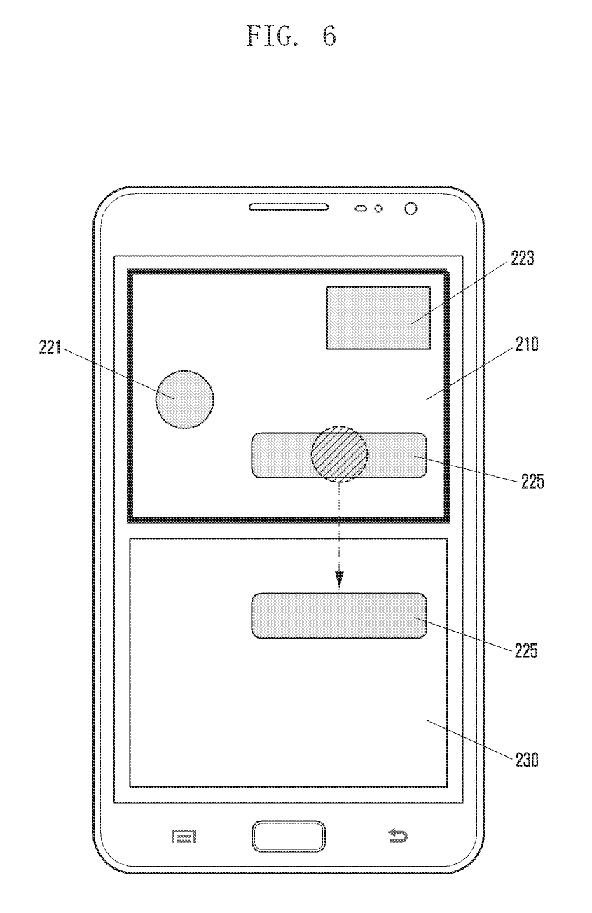

In a state wherein sharable objects are displayed as shown in FIG. 5, the user may select one of the sharable objects for sharing. For example, as shown in FIG. 6, the user may select (touch and hold) the object 225 as an object to be shared from among the sharable objects 221, 223 and 225 displayed on the first window 210, move (drag) the object 225 toward the second window 230, and release the object 225 at a region of the second window 230. Thereby, the object 225 (object to be shared) can be shared between the first window 210 and the second window 230.

In response to user input for sharing the object 225 selected as an object to be shared, the electronic device may move or copy the object 225 on the first window 210 to the second window 230 and display the same on the second window 230 as shown in FIG. 6.

During object sharing mode, only user input related to object sharing (e.g. selection and movement of an object to be shared) may be treated as valid and user input unrelated to object sharing may be treated as invalid and ignored. This is to distinguish object sharing operations from application manipulation operations, reducing user errors in usage of the electronic device. To this end, during object sharing mode, user events such as touch or hovering input occurring on a selected object may be delivered for processing to a user input event handling module other than the application running on the corresponding window.

In one embodiment, when an object 225 is selected as an object to be shared, the electronic device may provide a visual effect so that the object 225 is readily distinguished from other objects. For example, the electronic device may provide a virtual object moving according to user input by applying a motion blur effect to the object 225.

In one embodiment, as shown in FIG. 6, when the object 225 is selected as an object to be shared, the electronic device may maintain the highlight placed on the remaining sharable objects 221 and 223 or remove the highlight therefrom according to user settings.

Object sharing may be performed according to object attributes (e.g., copy, move, or copy and move) and user settings. Hence, in response to a request for sharing an object, the electronic device may examine the attribute of the object first and then process the request according to user settings within the limitations of the attribute. For example, if the object 225 selected as an object to be shared on the first window 210 has only a “move” attribute, the electronic device may move the object 225 from the first window 210 to the second window 230 regardless of user settings.

If the object 225 selected as an object to be shared on the first window 210 has only a “copy” attribute, the electronic device may copy the object 225 and send the copied version to the second window 230 while maintaining the object 225 on the first window 210 regardless of user settings. If the object 225 selected as an object to be shared on the first window 210 has a “move” and “copy” attribute, the electronic device may examine user settings and move or copy the object 225 to the second window 230 according to the user settings.

In various embodiments, object sharing mode may be deactivated or terminated in various ways according to user settings. That is, user settings may be configured so that object sharing mode is deactivated automatically, according to user input, or according to a UI element such as a termination button, but is not limited thereto. Hence, the electronic device may automatically deactivate or remain in object sharing mode when the object 225 selected as an object to be shared is shared with the second window 230 according to user settings for deactivation.

For example, when user settings are configured so that object sharing mode is automatically deactivated, the electronic device may automatically deactivate object sharing mode when the object 225 selected as an object to be shared is shared with the second window 230. When user settings are configured so that object sharing mode is deactivated according to user input or a termination button, the electronic device may remain in object sharing mode and keep the highlight placed on the sharable objects 221, 223 and 225 even when the object 225 selected as an object to be shared is already shared with the second window 230. Thereby, the user may make multiple objects shared in succession.

For deactivation of object sharing mode based on user input, the electronic device may deactivate object sharing mode when user input is detected in a region or window outside the region of the first window 210 in which the sharable objects 221, 223 and 225 are displayed with a highlight. That is, the electronic device may remain in object sharing mode until user input is detected in a region outside the sharable object region. Hence, for sharing of multiple sharable objects, the user may make the sharable objects 221, 223 and 225 shared in succession and then deactivate object sharing mode by selecting a region outside the sharable object region.

For deactivation of object sharing mode based on a termination button, the electronic device may be provided a separate termination button (physical or virtual) for deactivating object sharing mode. The electronic device may remain in object sharing mode until user input is detected on the termination button. That is, when user input is detected on the termination button during object sharing mode, the electronic device may deactivate object sharing mode. Hence, for sharing of multiple sharable objects, the user may make the sharable objects 221, 223 and 225 shared in succession and then deactivate object sharing mode by selecting the termination button.

In the embodiment described in FIGS. 2 to 6, to activate object sharing mode, when at least one window is selected (focused), the electronic device may examine whether a sharable object is present in the selected window. If a sharable object is present in the selected window, the electronic device may provide a sharing mode switching button 250. When the sharing mode switching button 250 is selected (touched) by the user, the electronic device may activate object sharing mode. However, the present disclosure is not limited thereto. Activation of object sharing mode may be achieved in various ways.

For example, when the first window 210 is selected according to user input as shown in FIG. 3, the electronic device may automatically activate object sharing mode. The user may recognize activation of object sharing mode through the first window 210 being focused.

As another example, when the first window 210 is selected according to user input as shown in FIG. 3, the electronic device may display a sharing mode switching button 250 for activating object sharing mode as shown in FIG. 4. When user input is detected on the sharing mode switching button 250, the electronic device may activate object sharing mode.

As another example, when the first window 210 is selected according to user input as shown in FIG. 3, the electronic device may examine whether a sharable object is present on the selected first window 210. If a sharable object is present on the selected first window 210, the electronic device may activate object sharing mode. If a sharable object is not present on the first window 210, the electronic device may notify the absence of a sharable object using a pop window.

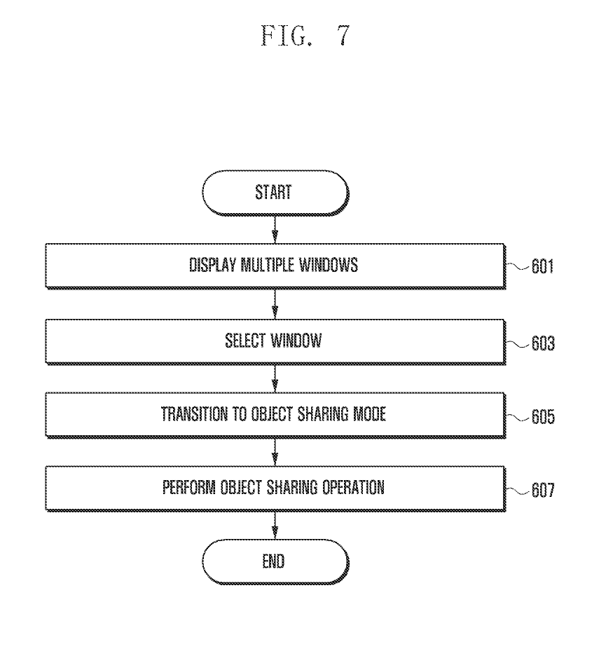

FIG. 7 is a flowchart illustrating a method for object sharing in an electronic device according to an embodiment of the present disclosure.

Referring to FIG. 7, at operation 601, the electronic device (or the control unit 170) displays multiple windows. The electronic device may display multiple windows including a first window 210 and second window 230 on a display unit functionally linked therewith.

At operation 603, the electronic device selects at least one of the multiple windows according to user input. The electronic device may select the first window 210 among the first window 210 and second window 230 and set focus on the first window 210.

At operation 605, the electronic device activates (transitions to) object sharing mode based on the window selected from among the multiple windows. When the first window 210 is selected, the electronic device may activate an object associated with or on the first window 210. As described before, the electronic device may activate object sharing mode in various ways according to user settings.

At operation 607, during object sharing mode, the electronic device performs operations for object sharing according to user input. In one embodiment, the electronic device may detect user input for selecting an object, and provide the selected object in a region related to the second window 230 according to the attribute of the user input. For example, the electronic device may examine the attribute of the user input, and provide, if the user input involves dragging an object on the first window 210 to the second window 230 and dropping the object on the second window 230, the object to the second window 230.

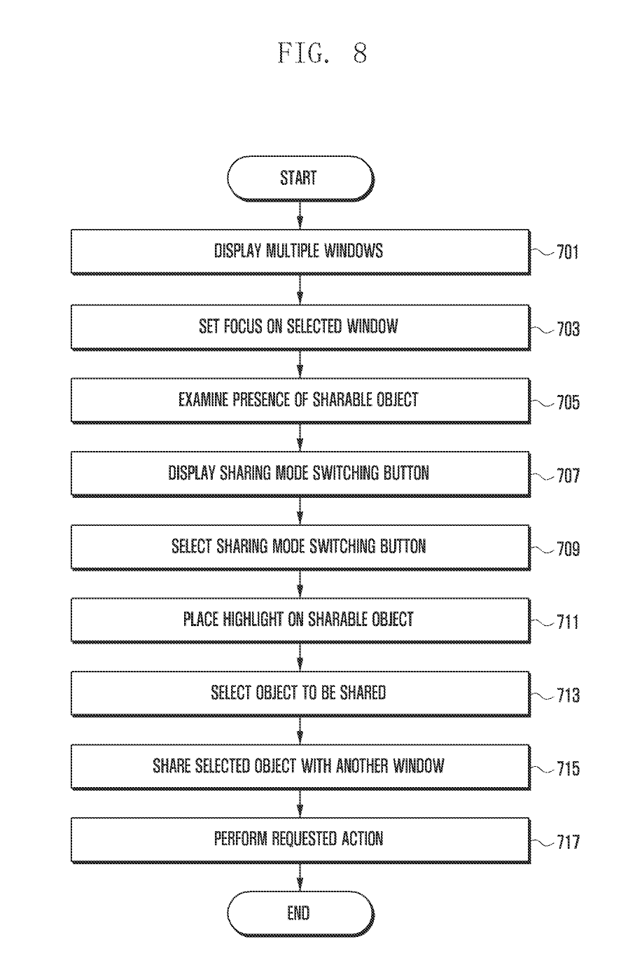

FIG. 8 is a flowchart illustrating another method for object sharing in an electronic device according to an embodiment of the present disclosure.

Referring to FIG. 8, at operation 701, the electronic device (or the control unit 170) displays multiple windows including a first window 210 and second window 230. At operation 703, the electronic device sets focus on a window selected from among the multiple windows.

At operation 705, the electronic device may examine whether a sharable object is present on the focused window. For example, when the first window 210 is focused, the electronic device may check whether a sharable object is present among objects (such as a text segment (character string), image, emoticon, URL tag, banner, and the like) within an application screen displayed on the first window 210. In one embodiment, operation 705 may be skipped.

At operation 707, the electronic device may display a sharing mode switching button based on the selected window.

At operation 709, the electronic device may detect user input for object sharing on the sharing mode switching button. At operation 711, the electronic device may place a highlight on a sharable object among objects on the selected window. In one embodiment, operations 709 and 711 may be skipped.

At operation 713, the electronic device selects at least one of sharable objects on the focused window as an object to be shared. At operation 715, the electronic device makes the selected sharable object shared with another window.

At operation 717, when the selected object is shared between windows, the electronic device may perform an action on the shared object according to user input. For example, assume that an album application is executed on the first window 210 and a message application is executed on the second window 230. When a photograph is selected from the album on the first window 210 and moved (or copied) to the second window 230, the message application executed on the second window 230 may create a message containing the photograph. After an object is shared, the electronic device may automatically deactivate (terminate) object sharing mode according to sharing mode settings. After an object is shared, the control unit 170 may remain in object sharing mode and repeat the object sharing operation for another object in response to user input according to sharing mode settings. Alternatively, the control unit 170 may perform window switching according to user input for selecting another window, identify a sharable object on the newly selected window with focus, place a highlight on the sharable object and move the sharable object to a different window for sharing.

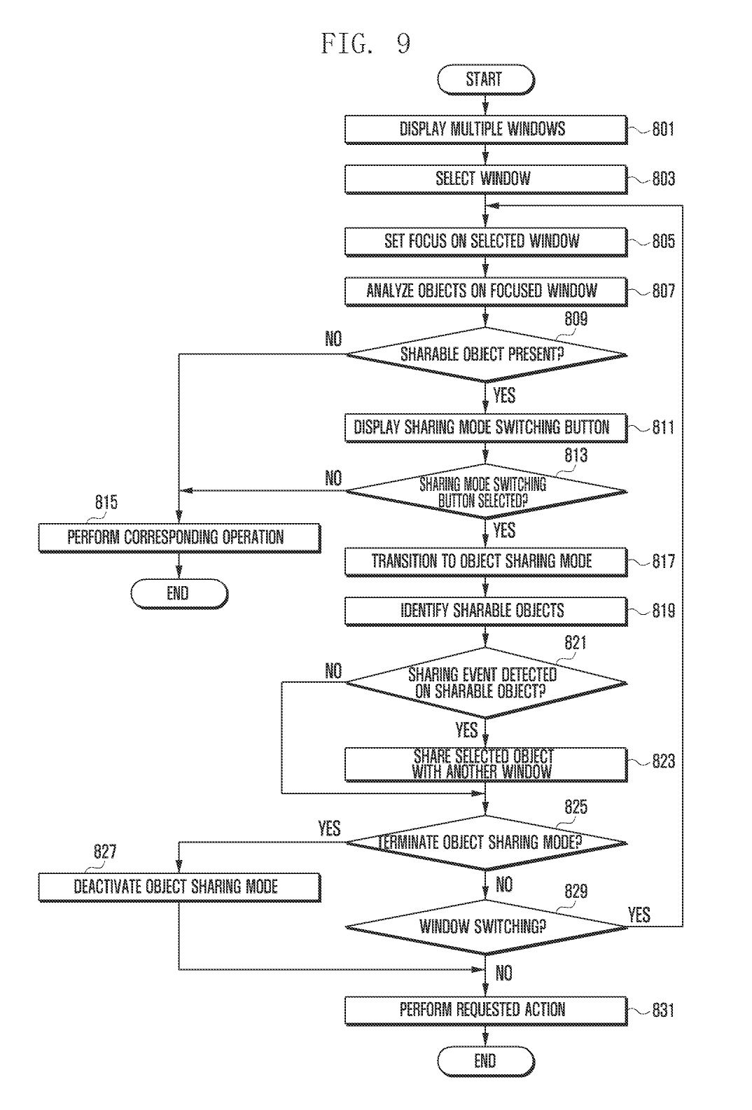

FIG. 9 is a flowchart illustrating another method for object sharing in an electronic device according to an embodiment of the present disclosure.

Referring to FIG. 9, at operation 801, the electronic device (or the control unit 170) displays multiple windows including a first window 210 and a second window 230 and may perform processing accordingly. At operation 803, the electronic device selects at least one of the multiple windows. At operation 805, the electronic device sets focus on the selected window.

At operation 807, the electronic device analyzes objects on the selected window with focus. At operation 809, the electronic device determines whether a sharable object is present among the objects on the selected window.

Upon determining that a sharable object is not present at operation 809, the electronic device proceeds to operation 815 at which the electronic device performs a corresponding operation. For example, the control unit 170 may display a popup window notifying absence of a sharable object on the selected window.

Meanwhile, upon determining that a sharable object is present at operation 809, the electronic device proceeds to operation 811 at which the electronic device displays a sharing mode switching button in a region. At operation 813, the electronic device examines whether user input is detected on the sharing mode switching button.

If user input is not detected on the sharing mode switching button at operation 813, the electronic device proceeds to operation 815 at which the electronic device performs a corresponding operation. For example, the electronic device may wait for user input for a time while displaying the sharing mode switching button. When user input is not detected on the sharing mode switching button within a time, the electronic device may remove the sharing mode switching button and deactivate or terminate object sharing mode. In addition, when user input is detected in a region other than the sharing mode switching button while the sharing mode switching button is displayed or is detected on a separate termination button, the electronic device may deactivate or terminate object sharing mode.

If user input is detected on the sharing mode switching button at operation 813, the electronic device proceeds to operation 817 at which the electronic device transitions to object sharing mode. For example, upon detection of user input on the sharing mode switching button, the electronic device may determine to activate object sharing mode and transition from multi-screen mode to object sharing mode. At operation 819, the electronic device identifies sharable objects on the selected window. Here, the electronic device may place a highlight on the sharable objects.

At operation 821, the electronic device determines whether a sharing event is detected on a sharable object in the selected window. Here, the sharing event may correspond to user input (touch or hovering) for selecting at least one of the sharable objects as an object to be shared. The sharing event may be a touch gesture involving moving (dragging) a sharable object on the selected window to a different window and releasing (dropping) the sharable object on the different window, but is not limited thereto.

If a sharing event is not detected at operation 821, the electronic device proceeds to operation 825.

If a sharing event is detected at operation 821, the electronic device proceeds to operation 823 at which the electronic device makes the selected sharable object (the object to be shared) shared with a different window indicated by the sharing event.

Thereafter, at operation 825, the electronic device determines whether a request for terminating object sharing mode is issued. If a request for terminating object sharing mode is issued at operation 825, the electronic device proceeds to operation 827 at which the electronic device deactivates the object sharing mode.

If a request for terminating object sharing mode is not issued at operation 825, the electronic device proceeds to operation 829 at which the electronic device checks whether a window switching request is issued by the user. For example, for sharing an object on another window, the user may issue a window switching request by selecting a different window and the electronic device may set focus on the newly selected window. While maintaining object sharing mode, window switching may be performed according to user input, such as double tap or multipoint touch on a target window, an attitude change of the electronic device, or a given voice command. While maintaining object sharing mode, window switching may be performed according to a switching button, such as a focus or menu button provided to each window or a separate window switching button.

If a window switching request is issued at operation 829, the electronic device returns to operation 805 and continues processing for object sharing by use of a newly selected window.

If a window switching request is not issued at operation 829, the electronic device proceeds to operation 831 at which the electronic device may perform a requested function. For example, the electronic device may make another sharable object shared in succession according to user input. In one embodiment, the electronic device may receive user input for selecting a different sharable object on the first window and providing the object to the second window, and may provide the selected object in a region associated with the second window. Alternatively, for manipulation of an object shared with the different window, the electronic device may display a list of options applicable to the shared object on the different window, or may display the different window containing the shared object in a full-screen format and provide a list of applicable options.

Meanwhile, in various embodiments of the present disclosure, modules may be realized in software, firmware, hardware or a combination thereof. Some or all modules may be combined into one entity without change in functions of the modules. In addition, operations may be executed in sequence, by repetition, or in parallel, or a combination thereof. Some operations may be omitted or new operations may be added.

Various embodiments of the present disclosure may be implemented as computer programs and may be stored in various computer readable storage media. The computer readable storage media may store program instructions, data files, data structures, and combinations thereof. The program instructions or software may include instructions developed specifically for the present disclosure and widely known general-purpose instructions.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present invention.

The program instructions or software may be stored in the form of volatile or non-volatile storage such as, for example, a storage device like magnetic media such as a hard disk and floppy disk, optical media such as a Compact Disc Read Only Memory (CD-ROM) and Digital Versatile Disc (DVD), magneto-optical media such as a floptical disk, and memory devices such as a ROM, RAM and flash memory. The program instructions may include machine codes produced by compilers and high-level language codes executable through interpreters. Each hardware device may be replaced with one or more software modules to perform operations specific to the present disclosure, and vice versa. It will be appreciated that the storage devices and storage media are exemplary embodiments of machine-readable storage that are suitable for storing a program or programs comprising instructions that, when executed, implement exemplary embodiments of the present invention. Accordingly, exemplary embodiments provide a program comprising code for implementing apparatus or a method as claimed in any one of the claims of this specification and a machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for sharing objects in an electronic device, the method comprising:
displaying multiple windows including a first window and a second window on a display unit functionally linked with the electronic device;
selecting the first window;
activating objects associated with the first window;
receiving an input signal for selecting at least one of the objects associated with the first window; and
presenting the selected at least one of the objects in a region associated with the second window according to an attribute of the input signal.

2. The method of claim 1, wherein the selecting of the first window comprises displaying supplementary information emphasizing the first window in a region related to the first window.

3. The method of claim 1, wherein the activating of the objects associated with the first window comprises:
checking whether a sharable object is present among the objects associated with the first window; and
determining to activate an object sharing mode when a sharable object is present among the objects associated with the first window.

4. The method of claim 3, wherein the activating of the objects associated with the first window comprises displaying supplementary information emphasizing the sharable object.

5. The method of claim 1, wherein the activating of the objects associated with the first window comprises presenting a sharing mode switching button for activating an object sharing mode in a region of the multiple windows.

6. The method of claim 5, wherein the presenting of the sharing mode switching button comprises:
checking whether an object sharable with the second window is present among the objects associated with the first window; and
displaying the sharing mode switching button when an object sharable with the second window is present.

7. The method of claim 5, wherein the activating of the objects associated with the first window comprises activating an object sharing mode in response to an input signal related to the sharing mode switching button.

8. The method of claim 1, wherein the presenting of the selected at least one of the objects comprises:
examining the attribute of the input signal; and
presenting the selected at least one of the objects to the second window when the attribute indicates dragging an object on the first window and dropping the object on the second window.

9. The method of claim 1, wherein the presenting of the selected at least one of the objects comprises automatically deactivating the activated objects.

10. The method of claim 1, wherein the presenting of the selected at least one of the objects comprises deactivating the activated objects in response to a user input detected on a region other than a sharable object on the first window.

11. The method of claim 1, wherein the presenting of the selected at least one of the objects comprises:
presenting a user interface element for object deactivation;
receiving an input signal related to an activated object through the user interface element; and
deactivating the activated object upon reception of the input signal.

12. The method of claim 1, wherein the presenting of the selected at least one of the objects comprises receiving an additional input signal for presenting another object on the first window to the second window.

13. The method of claim 1, wherein the presenting of the selected at least one of the objects comprises moving or copying an object on the first window to the second window.

14. The method of claim 13, wherein the presenting of the selected at least one of the objects comprises moving or copying an object according to the attribute of the object and user settings.

15. The method of claim 1, wherein the presenting of the selected at least one of the objects comprises displaying a direction indicator in a region between the first window and the second window.

16. An electronic device comprising:
a display unit functionally linked with the electronic device configured to display multiple windows including a first window and a second window, and to display objects on the first and second windows;
a touch sensor configured to detect input signals for, selecting at least one of the multiple windows, selecting at least one object on the selected at least one of the multiple windows, and sharing the selected at least one object; and
a control unit configured to control a process of activating objects associated with the first window according to selection of the first window, and to present, according to an attribute of the input signals for selecting the at least one object, the selected at least one object in a region associated with the second window.

17. The electronic device of claim 16, wherein the control unit is further configured to check whether a sharable object is present among the objects associated with the first window, and to determine to activate an object sharing mode when a sharable object is present among the objects associated with the first window.

18. The electronic device of claim 17, wherein the control unit if further configured to display supplementary information emphasizing the first window or the sharable object in a region related to the first window.

19. The electronic device of claim 17, wherein the control unit is further configured to present a sharing mode switching button for activating object sharing mode in a region of the multiple windows.

20. The electronic device of claim 17,
wherein the control unit is further configured to display a sharing mode switching button when an object sharable with the second window is present among the objects associated with the first window, and
wherein the control unit is further configured to activate an object sharing mode in response to an input signal related to the sharing mode switching button.

21. The electronic device of claim 16, wherein the control unit is further configured to automatically deactivate an activated object, or to deactivate an activated object based on user input detected on a region other than a sharable object on the first window or user input related to the activated object detected through a user interface element for object deactivation.

22. The electronic device of claim 16, wherein the control unit is further configured to move or copy an object on the first window to the second window according to the attribute of the object and user settings.

23. A non-transitory computer readable storage medium storing a program implementing a method for sharing objects in an electronic device, the method comprising:
displaying multiple windows including a first window and a second window on a display unit functionally linked with the electronic device;
selecting the first window;
activating objects associated with the first window;
receiving an input signal for selecting at least one of the objects associated with the first window; and
presenting the selected at least one of the objects in a region associated with the second window according to an attribute of the input signal.
